(19) United States
(12) Patent Application Publication
(10) Pub. No.: US 2009/0156239 A1
(43) Pub. Date: Jun. 18, 2009

(54) Method for developing a potential customer profile using text messaging

(76) Inventor: Moses E. Rodin, Tallahassee, FL (US)

Correspondence Address: John Wiley Horton, Attoney;Pennington, Moore, Wilkinson, Bell & Dunbar, P.A., 2nd Floor, 215 S. Monroe St., Tallahassee, FL, 32301, US

(21) Appl. No.: 12/001,900

(22) Filed: Dec. 13, 2007

(51) Int. Cl. H04Q 7/20

(52) U.S. Cl. 455/466

(57) ABSTRACT

A method for collecting information about potential buyers and matching the potential buyers with appropriate products or services. The present invention accomplishes these functions by providing a call center for receiving text message product inquiries from potential buyers. The call center captures the potential buyer's telephone number and associates the telephone number with a particular product. This association is stored for later reference.

### BACKGROUND OF THE INVENTION

1. Field of the Invention

This invention relates to the field of customer profiling. More specifically, the invention comprises a method for constructing a customer profile and identifying target customer groups using text messaging.

2. Description of the Related Art

Locating a new home can be a challenging task for a prospective home buyer. Prospective home buyers typically drive around desirable neighborhoods and look for posted “FOR SALE” signs. These signs have a contact phone number that the interested person can call to gain more information about the house or to arrange a walk through. Unfortunately, a real estate agent is not always available to take a call from an interested person. Some interested persons may choose to leave a message with a call-back number, but others will hang up in frustration. Also, since an interested person is often driving when a particular property of interest is located, the interested person may not have a convenient way to record information about the parcel if the real estate agent is available to take the phone call.

From the perspective of a real estate agent, significant time is wasted showing houses to interested persons when a house does not even fall within the buyer's criteria. A real estate agent may also lose a sale if they are not able to provide information to the buyer when the buyer is most interested. Some real estate agents feel that it is necessary to carry a cellular phone with them when they show a house to an interested person so that he or she can continue to field calls from other interested persons. Of course, some buyers may consider accepting a phone call from another interested person to be rude behavior.

Also, a real estate agent often represents multiple sellers. In some instances, a potential buyer may determine that one house does not meet the buyer's criteria. The seller's agent may know that a potential buyer looked at a parcel and did not make an offer, but the agent typically does not know why the buyer ultimately elected not to make an offer. Even though the parcel viewed by the potential buyer did not meet the buyer's criteria, it is possible that the real estate agent may know of another parcel of land that meets the potential buyer's criteria. Thus, real estate agents would benefit from a system which allows the agent to better identify potential buyer's buying criteria to match potential buyers with parcels that are for sale.

The real estate market is merely one field in which buyers, sellers, and agents can benefit from sharing “product” and buyer information. The provision of information that would allow sellers to match potential customers with products is valuable in many other fields as well.

### BRIEF SUMMARY OF THE INVENTION

The present invention comprises a method for collecting information about potential buyers and matching the potential buyers with appropriate products or services. The present invention accomplishes these functions by providing a call center for receiving text message product inquiries from potential buyers. The call center captures the potential buyer's telephone number and associates the telephone number with a particular product. This association is stored for later reference.

In one embodiment, the present invention provides these functionalities in conjunction with a method for conveying information about a parcel of real property to an interested person. The method includes posting a unique house identifier code for the parcel of real property in a place that is viewable by the interested person. As an example, the unique house identifier code may be posted on a sign on the property or it may be printed in a circulated advertisement such as a real estate listings circular.

A call center is further provided to receive data transmissions from potential buyers. In the preferred embodiment, cellular text messaging protocols are used. The interested person simply transmits the unique house identifier code via text message to the call center. The call center automatically receives the data transmission, records the interested person's phone number, retrieves a description of the property from a listings database, and transmits the description of the parcel to the interested person. The description may also be transmitted as a text message. The description preferably contains the asking price for the parcel, the square footage of the house, and contact information for the real estate agent associated with the parcel.

The call center can also be accessed by real estate agents to gain information about interested persons. For example, the real estate agent can query the call center to see how many inquiries a particular parcel has received. The real estate agent can also query the call center to see other parcels of interest to an interested person. Thus, using the system, a seller can (1) learn names and phone numbers for interested persons, (2) cross-reference other properties of interest to the person, and (3) build a “buyer profile” using the data.

### BRIEF DESCRIPTION OF THE SEVERAL VIEWS OF THE DRAWINGS

FIG. 1 is a schematic, showing the present invention.

FIG. 2 is a schematic, showing the present invention.

FIG. 3 is a front view, showing a sign with a unique house identifier code.

FIG. 4 is a plan view, showing the display of a cellular phone.

FIG. 5 is a plan view, showing the display of a cellular phone.

REFERENCE NUMERALS IN THE DRAWINGS

| | | | |
|---|---|---|---|
| 10 | cellular telephone | 12 | call center |
| 14 | listing database | 16 | step |
| 18 | step | 20 | step |
| 22 | step | 24 | step |
| 26 | step | 28 | step |
| 30 | list number | 32 | call center number |
| 34 | sign | 36 | display |
| 38 | text field | 40 | phone number field |
| 42 | description | | |

### DETAILED DESCRIPTION OF THE INVENTION

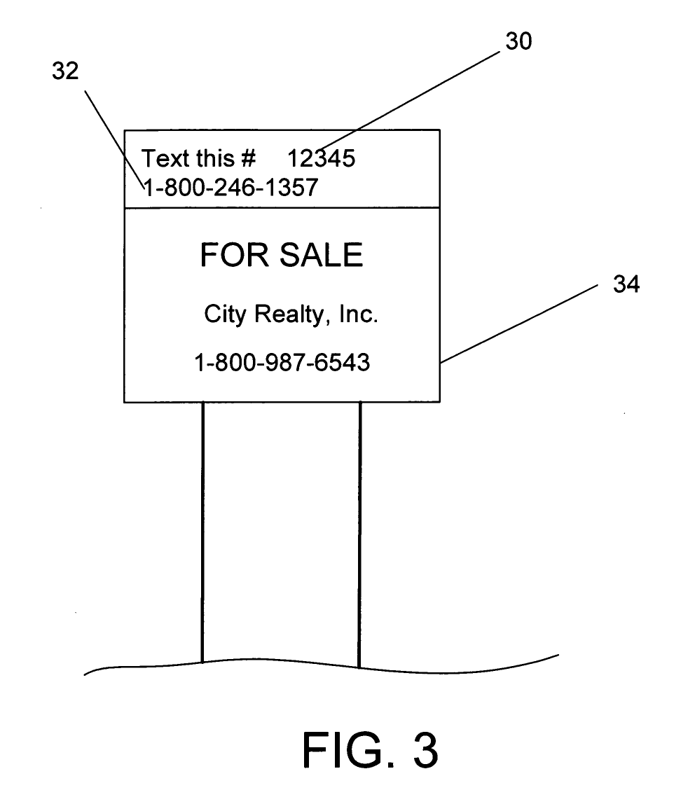

The present invention comprises a method for collecting information about potential buyers and matching the potential buyers with appropriate products or services. Although the invention is useful in many fields, the invention will be discussed in the context of real estate sales. In this embodiment, the method includes posting a unique house identifier code for the parcel of real property in a place that is viewable by the interested person. The unique house identifier code is preferably an alpha-numeric code, such as a list number. As an example, as illustrated in FIG. 3, the unique house identifier code may be posted on sign 34 as list number 30. Call center number 32, the purpose of which will be described in greater detail subsequently, is also provided on sign 34. Sign 34 may be posted on the parcel in a position that is viewable to potential buyers. Alternatively, the unique house identifier code may be printed in a circulated advertisement such as a real estate listings circular. The house identifier code may also be available on-line.

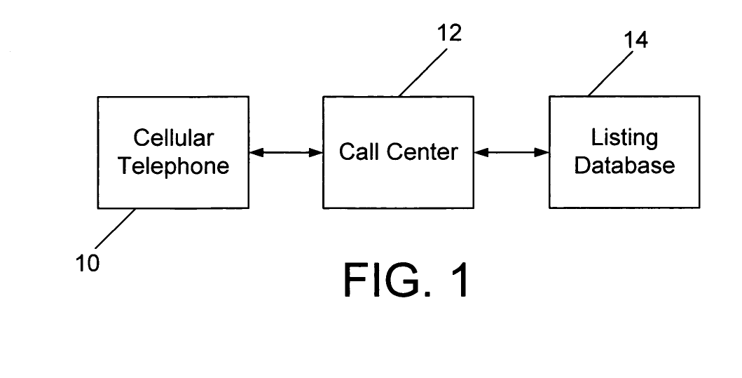

As illustrated in FIG. 1, the present invention uses call center 12 as an interface between cellular telephone 10 and listing database 14. Listing database 14 contains descriptions of various parcels of land that are provided by real estate agents subscribing to the service. The descriptions preferably include the asking price, the square footage of the house on the parcel, the acreage of the land, and identifying information for the real estate agent associated with the listing. Each parcel in listing database 14 is indexed by its unique house identifier code for reference. Each parcel is also associated with the real estate agent that submitted the property in listing database 14.

Call center 12 is provided to receive data transmissions from potential buyers. In the preferred embodiment, cellular text messaging protocols are used. The interested person simply enters the number of the call center and transmits the unique house identifier code via text message to the call center. Call center 12 receives the data transmission, records the interested person's phone number, preferably cross-references the phone number to a name using a directory-listing database, retrieves a description of the property from listings database 14, and transmits the description of the parcel to cellular telephone 10.

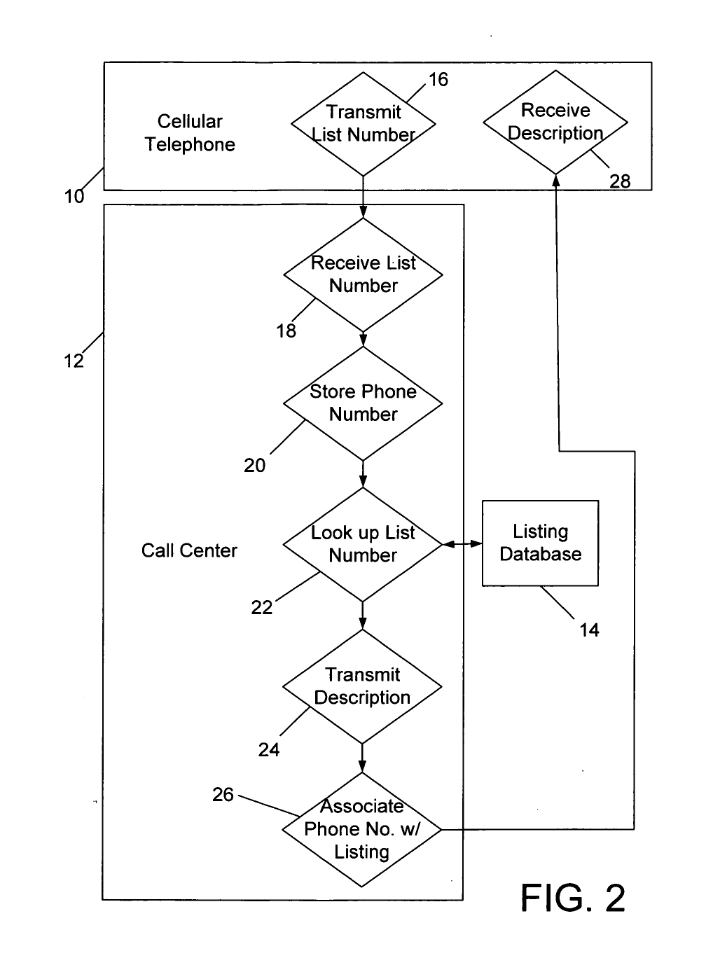

As illustrated in FIG. 2, the buyer first transmits the listing number or unique house identifier code to call center 12 using cellular telephone 10, as indicated by step 16. Call center 12 receives the data transmission, including the listing number and the phone number of the potential buyer as indicated by step 18. As indicated by step 20, call center 12 stores the potential buyer's phone number in permanent memory for later reference. Call center 12 then looks up the list number in listing database 14 and retrieves the description of the property as indicated by step 22. As indicated by step 24, call center 12 transmits the description of the property as a text message to cellular telephone 10. Cellular telephone 10 receives the description as indicated by step 28. The phone number of the potential buyer is associated with the inquired listing as indicated by step 26. Call center 12 preferably performs all of these steps automatically without outside human assistance. Thus, the reader should appreciate that call center 12 may be a computer with an integrated cellular transceiver.

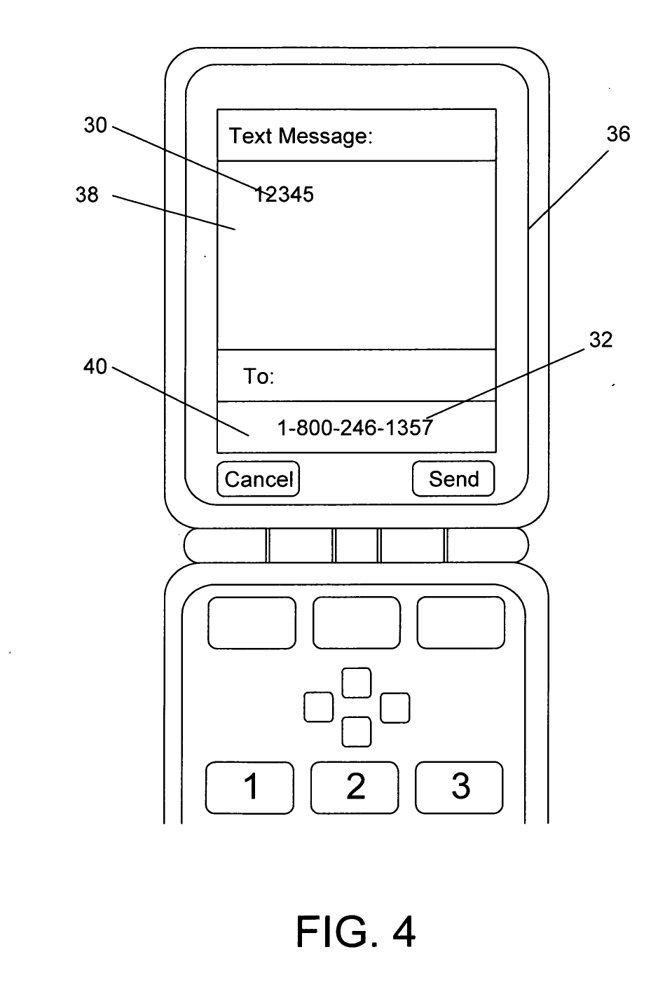

As illustrated in FIG. 4, a potential buyer simply needs to access the text messaging feature of his or her cellular telephone to gain information about a property using the present method. Looking at display 36, the potential buyer inputs list number 30 in text field 38 and call center number 32 in phone number field 40. When the user presses the appropriate button (the “send” button), list number 30 is transmitted to call center 12.

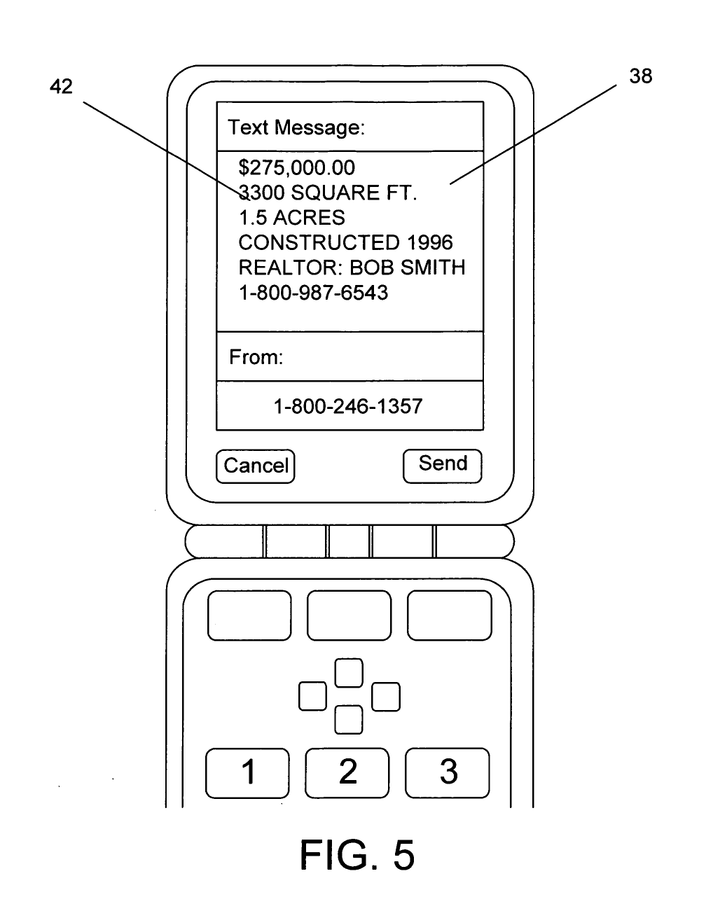

As illustrated in FIG. 5, once call center 12 retrieves the description of the property, the description is transmitted to the potential buyer's cellular telephone where it is displayed in text field 38 as description 42.

It should be noted that pictures of the exterior or interior of the house may also be transmitted when available. Although pictures may be transmitted with description 42, it is even more preferable to transmit pictures in a second message. In this case, description 42 may identify whether pictures are available for the listing and provide a new identifier number. The interested person can then send the new identifier number as a text message to the call center to obtain the pictures. In this case, call center 12 performs substantially the same steps as in FIG. 2. Since the new identifier number references pictures associated with the listing, call center 12 retrieves pictures from listing database 14 and transmits the pictures to the interested person.

The call center can also be accessed by real estate agents to gain information about interested persons. For example, the real estate agent can query the call center to see how many inquiries a particular parcel has received. A real estate agent subscribing to the services of call center 12, may access this information through the Internet or other connection means. If the Internet is used, the real estate agent may go to a designated web page to view all listings submitted by the real estate agent to call center 12. The phone numbers of potential buyers inquiring about a property will be listed with each property listing. The real estate agent can also query the system to see other parcels of interest to any interested person.

The following two tables (TABLE ONE and TABLE TWO) illustrate one possible embodiment of listings database 14. As shown in TABLE ONE, going from left to right across the table, each real estate listing has a unique listing number (a unique identifier code), an address, the seller's realtor, the phone number of the seller's realtor, the asking price, the square footage of the house, the acreage of the lot, the year the house was constructed, an indicator for whether pictures of the house have been uploaded to the server, and a unique identifier for retrieving the pictures.

TABLE ONE

| List | | | Realtor | | Sq | | Build | | Pic |
|---|---|---|---|---|---|---|---|---|---|
| No. | Address | Realtor | Phone | Price | Ft | Acreage | Yr | Pics | Id |
| 12345 | 789 | Bob | 1-800- | $275,000 | 3300 | 1.5 | 1996 | Y | 11110 |
| | Main | Smith | 987- | | | | | | |
| | Street | | 6543 | | | | | | |
| 12346 | 765 | Bob | 1-800- | $500,000 | 4200 | 1.5 | 2005 | Y | 11111 |
| | Main | Smith | 987- | | | | | | |
| | Street | | 6543 | | | | | | |
| 12347 | 408 | Bob | 1-800- | $250,000 | 2200 | 1 | 1997 | Y | 11112 |
| | Park | Smith | 987- | | | | | | |
| | Street | | 6543 | | | | | | |
| 12348 | 550 | Bob | 1-800- | $300,000 | 3200 | 1.1 | 2001 | Y | 11113 |
| | Park | Smith | 987- | | | | | | |
| | Street | | 6543 | | | | | | |

TABLE TWO is a second table maintained by call center 12. Call center 12 uses the table illustrated in TABLE TWO to track phone calls placed to the call center. Each phone number is cross-referenced with a phone listings database to retrieve a name associated with the phone number. Call center 12 tracks the identifier number that was transmitted to call center 12 by the interested person as well as the date that the identifier number was transmitted. This database tracks requests for descriptions and requests for pictures.

TABLE TWO

| Phone No. | Name | Identifier No. | Date |
|---|---|---|---|
| 555-6789 | John Smith | 12345 | Apr. 4, 2007 |
| 555-1234 | Jane Doe | 12345 | Apr. 4, 2007 |
| 555-2468 | Mark Thompson | 12345 | Mar. 30, 2007 |
| 555-1357 | Jennifer Miller | 12345 | Mar. 29, 2007 |
| 555-6789 | John Smith | 11110 | Apr. 4, 2007 |
| 555-1234 | Jane Doe | 11110 | Apr. 4, 2007 |
| 555-1357 | Jennifer Miller | 11110 | Mar. 29, 2007 |
| 555-6789 | John Smith | 12346 | Apr. 4, 2007 |
| 555-6789 | John Smith | 12347 | Apr. 4, 2007 |
| 555-6789 | John Smith | 12348 | Apr. 4, 2007 |
| 555-6789 | John Smith | 11113 | Apr. 4, 2007 |

As discussed previously, subscribing real estate agents can utilize the call center to gain valuable information regarding both the level of interest a property is receiving and the potential buyers looking at the property. As shown in TABLE THREE, a subscribing real estate agent may look up one of his or her listings to see how people have called call center 12 inquiring about the particular property. In the example shown in TABLE THREE, the real estate agent can see that four interested persons have requested information about the property. Of the four that requested information, three people also requested pictures. The real estate agent can also see the phone numbers and dates of inquiry.

TABLE THREE

| | |
|---|---|
| Listing No | 12345 |
| Address | 789 Main Street |

| Caller | Phone Number | Date of Inquiry | Picture Request |
|---|---|---|---|
| John Smith | 555-6789 | Apr. 4, 2007 | Y |
| Jane Doe | 555-1234 | Apr. 4, 2007 | Y |
| Mark Thomnson | 555-2468 | Mar. 30, 2007 | N |
| Jennifer Miller | 555-1357 | Mar. 29, 2007 | Y |

Upon reviewing the list of interested persons requesting information about a specific property, the real estate agent may want to find out more information about one of the potential buyers. If an interested person has inquired about more than one listing, his or her name appears with an underline (as shown in TABLE THREE). The real estate agent can select the name (such as by cursoring over name with a mouse and pressing the appropriate button) to gain more information about the potential buyer. As shown in TABLE FOUR, the real estate agent can see all of the inquiries from the potential buyer. The real estate agent can use this information to assess the potential buyer's objectives and potential level of interest. For example, the real estate agent can evaluate the information to determine which neighborhoods the buyer is considering, as well as size and price requirements.

TABLE FOUR

| Name | John Smith |
|---|---|
| Phone No | 555-6789 |

| Listing | | Date of | Picture | Asking | Sq | Acre- |
|---|---|---|---|---|---|---|
| No. | Address | Inquiry | Request | Price | Footage | age |
| 12345 | 789 Main | Apr. 4, 2007 | Y | $275,000 | 3300 | 1.5 |
| | Street | | | | | |
| 12346 | 765 Main | Apr. 4, 2007 | N | $500,000 | 4200 | 1.5 |
| | Street | | | | | |
| 12347 | 408 Park | Apr. 4, 2007 | N | $250,000 | 2200 | 1 |
| | Street | | | | | |
| 12348 | 550 Park | Apr. 4, 2007 | Y | $300,000 | 3200 | 1.1 |
| | Street | | | | | |

Such a system may be equipped with additional, advanced features to provide helpful information to real estate agents. For example, the system could be configured to compute a “buyer score” for each interested person querying the system. To compute a buyer score, the system could compare the price, size, and location of a particular house to all other properties queried by the interested person. In the example shown in TABLE FOUR, the system might report a low buyer score for John Smith and Listing Number 12346. This property is significantly more expensive and larger than the other three listings John Smith queried. Furthermore, Mr. Smith did not request pictures for this listing which is consistent with a low interest evaluation. Thus, Mr. Smith may be rated as a “3 out of 10” buyer for Listing Number 12346. Mr. Smith would have a higher buyer score for Listing Number 12345, since the location, size, and price are closer to the other queried listings. Mr. Smith may be scored as an “8 out of 10” buyer for this property.

Many other factors may be considered when computing a buyer score including the date of the inquiry, inquiry trends (e.g., whether most recent inquiries were for properties with lower asking prices or properties of smaller size), picture requests for similar listings, and the relative value of a listing compared to similar inquiries (e.g., whether the asking price per square foot is higher or lower than inquiries for comparable listings).

There are many ways a buyer score could be computed and the score can be scaled in various ways. The buyer score may even expressed in terms of “high interest,” “medium interest,” or “low interest” based on the scoring range. By now the reader should appreciate that such a scoring system may help realtors better assess the interest level of potential buyers. The realtor can use this information to implement more effective time-management and marketing strategies. The realtor can also use this information to assess whether the asking price should be adjusted up or down for a listing.

Although the discussion of the present invention has thus far focused on the field of real estate sales, the present invention is useful in other applications in which buyers desire information about a product and sellers desire information about potential customers. As another example, the present invention may also be employed by vendors at a product fair or show such as a boat show. It is common for a boat vendor to bring many different boats to a show for public viewing. It is often difficult to assist-all of the potential customers at the show.

Using the present method, a boat vender could post identifier codes on the boat similar to the identifier codes that are posted on the parcels of real property in the real estate example. The potential customer may query the call center using text messaging (as described previously with the real estate example) to gain more information about a particular boat. The call center would send information about the boat to the customer's cellular telephone and store the customer's phone number in a database. Once the show has concluded, the vendor can recall a list of potential customers from the call center to identify the potential customers who sent text inquiries to the call center. The vendor can further ascertain the interests of each potential customer by evaluating the queries transmitted by the potential customer.

The preceding description contains significant detail regarding the novel aspects of the present invention. It is should not be construed, however, as limiting the scope of the invention but rather as providing illustrations of the preferred embodiments of the invention. Thus, the scope of the invention should be fixed by the following claims, rather than by the examples given.

Having described my invention, I claim:

1. A method for conveying information about an item to an interested person and collecting information about potential interested person, comprising the steps of:
a. providing a unique identifier code for said item in a location that is viewable by said interested person;
b. providing a call center, said call center configured to receive data transmissions from said interested person, said data transmissions including said unique identifier code and a phone number for said interested person, said call center further configured to automatically retrieve a description of said item and automatically transmit said description to said interested person;
c. automatically transmitting said description of said item to said interested person when said interested person transmits said unique identifier code to said call center; and
d. automatically recording said phone number and associating said phone number with said item when said interested person transmits said unique identifier code to said call center.

2. The method of claim 1, wherein said unique identifier code identifies a parcel of real property and said call center is configured to automatically retrieve a description of said parcel of real property and automatically transmit said description to said interested person when said interested person transmits said unique identifier code to said call center.

3. The method of claim 2, further comprising the step of transmitting said phone number of said interested person to a real estate agent associated with said parcel of real property.

4. The method of claim 2, further comprising the step of transmitting said phone number of said interested person together with information about other properties of interest to said interested person to a real estate agent associated with said parcel of real property.

5. The method of claim 2, wherein said description of said parcel of real property includes an asking price.

6. The method of claim 5, wherein said description of said parcel of real property includes a picture.

7. The method of claim 5, wherein said description includes an approximate square footage of a house.

8. The method of claim 2, wherein said unique identifier code is transmitted to said call center as a text message.

9. The method of claim 2, wherein said description of said parcel of real property is transmitted to said interested person as a text message.

10. The method of claim 9, wherein said description is transmitted to the cellular phone which transmitted said unique house identifier code to said call center.

11. The method of claim 2, wherein said description includes a phone number for a real estate agent associated with said parcel of real property.

12. The method of claim 2, wherein said call center automatically retrieves said description of said parcel of real property from a listings database using said unique identifier code when said interested person transmits said unique identifier code to said call center, said listings database further containing descriptions for other parcels of real property.

13. The method of claim 2, wherein said unique house code is posted on a sign on said parcel of real property.

14. The method of claim 2, wherein said unique house identifier code is posted in a circulated advertisement.

15. The method of claim 1, further comprising the step of transmitting said phone number of said interested person to a vendor associated with said item.

16. The method of claim 1, further comprising the step of transmitting said phone number of said interested person together with information about other items of interest to said interested person to a vendor associated with said item.

17. The method of claim 1, wherein said unique identifier code is transmitted to said call center as a text message.

18. The method of claim 1, further comprising the step of evaluating said interested person's potential interest in said item utilizing other queries transmitted to said call center from said phone number.

19. The method of claim 1, further comprising the step of evaluating said interested person's potential interest in a second item utilizing queries transmitted to said call center from said phone number.
